(19) United States
(12) Patent Application Publication
(10) Pub. No.: US 2010/0216432 A1
(43) Pub. Date: Aug. 26, 2010

(54) Wireless device for receiving calls to automatically transmit messages of current device location

(76) Inventor: Raymound Wu, Saratoga, CA (US)

Correspondence Address: Bo-In Lin, 13445 Mandoli Drive, Los Altos Hills, CA, 94022, US

(21) Appl. No.: 12/658,437

(22) Filed: Feb. 11, 2010

Related U.S. Application Data
(60) Provisional application No. 61/207,369, filed on Feb. 11, 2009.

(51) Int. Cl. H04W 4/02; H04W 12/08; G01S 19/14; G01S 19/03

(52) U.S. Cl. 455/411; 455/414.3; 342/357.55; 342/357.4

(57) ABSTRACT

A wireless location tracking device (WLTD) includes a global position system (GPS) for receiving signals and generating data for determining a geographic location of the wireless location tracking device (WLTD). The WLTD further includes a transceiver for receiving an incoming call from a caller requesting a location of the wireless location tracking device. A processor includes a map database for receiving and applying data from the GPS to determine a geographic location of the WLTD in reference to the map database. The processor further controls the transceiver to automatically call back the caller for transmitting a short message to indicate the geographic location of the WLTD.

This application claims a priority according to a pending U.S. patent application 61/207,369 filed on Feb. 11, 2009 by the same Applicant of this Application, the benefit of the filing dates are hereby claimed under Title 35 of the United States Code.

### BACKGROUND OF THE INVENTION

1. Field of the Invention

This invention relates generally to a signal transmission system implemented with wireless signal transmitters and receivers and global position system (GPS). More particularly, this invention is related to a signal reception/transmission device integrated with a global position system (GPS) and processor with map data stored on the device for ready to respond to calls to automatically transmit wireless messages, e.g., a short message (SM),directly to the caller to provide current device location.

2. Description of the Prior Art

Conventional system configuration and methods for tracking and receiving messages of a device location is still limited by complicated processes that require multiple steps of calls and responses to calls through a message processing or management center. The system configurations and methods of communications are time consuming and involve multiple links thus causes increase of costs and unreliability when applied to the location tracking operations.

Short messages have been broadly employed to transmit different kinds of information and data. For example, in Patent Application 20020084888, a system for sending and receiving personal information using a mobile terminal is disclosed. In that patent application, personal information is sent using a short message service with attached identification information. Accordingly, when a receiving mobile terminal receives the short message, the attached identification information allows the receiving mobile terminal to distinguish and process the short message for personal information differently from other general short messages.

In another Patent Application 20050020287, a location-based reference information transmitted through a wireless communication system is disclosed that provides a ‘411xx’ value added service to wireless users. The disclosed ‘411xx’ service allows a mobile user who may be unfamiliar with their current geographic location to obtain quick, accurate, and current information relating to the geographic area, e.g., different services in their current location, stores, libraries, gas stations, etc., via a mobile terminated (MT) short message system (SMS) message. In addition to the traditional ‘4-1-1’ dialed digits, a mobile user would also dial a number (or numbers) representing a feature code for a particular service, e.g., nearby ATMs, or traffic information. Upon receiving a 411xx call, the message service center (MSC) generates an ORREQ/TCAP trigger based on a translation of the requested service represented by the extra ‘xx’ digits.

In U.S. Pat. No. 6,738634, Shin discloses a communication system and a method for performing short message services in the communication system. The communication system includes a radio link control (RLC) layer for dividing a data unit having a first length corresponding to short messages transmitted from a higher layer on a down link into data units having second lengths, and for reconstructing data units having third lengths transmitted from a lower layer on an up link into data units having fourth lengths; and a media access control (MAC) layer for multiplexing logical channels assigned for the data units having the second lengths on the down link with different logical channels, performing scheduling for the data units having the second lengths to obtain schedule messages, and de-multiplexing transmission channels multiplexed from the lower layer on the up link.

In another Patent Application 20040196866, a method for transmitting and recording schedule using a short message service is disclosed. This method is provided for transmitting a common schedule message to a plurality of mobile terminals using a short message service (SMS) in a mobile terminal having an SMS function and a schedule function, and enabling a mobile terminal receiving the schedule message to record the received schedule message therein as a schedule. If a user selects a schedule transmission for transmitting a schedule registered in the mobile terminal to another mobile terminal, the mobile terminal converts a data format for the schedule into a data format of a schedule-recordable SMS message, and then transmits the schedule-recordable SMS message. To record a schedule, the mobile terminal receiving a schedule message converts a data format of the received SMS message into a format of schedule-recordable data and records the converted data therein as a schedule, if schedule recording is selected by the user.

Other than the applications of short messages (SM) to transmit textual messages, transmission of other types of signal messages including audio or video signals have not bee applied to transmit vehicle location or schedule information that may be relevant to the invention of this application. Specifically, in another Patent Application 20060164259, a wireless mobile vehicle real-time tracking and notification systems are disclosed. The system features a system and methods for notifying passengers of an approaching vehicle. Utilizing such a system and methods, passengers can remain in a safe, controlled environment, avoiding harsh environmental conditions and excessive waiting times, instead arriving at their pick-up point closer and prior to a vehicle's arrival. More specifically, the patent application relates to a bus notification system wherein passengers are able to know the location and estimated arrival time of the bus several minutes before its arrival at a specified location along the bus route. The patent application also features a system and methods for locating an in-transit vehicle and for providing real-time mapping and monitoring of such in-transit vehicles. The disclosures made in Application 20060164259 are hereby incorporated by reference in this Patent Application. The disclosures made in Application 20060164259 however are often limited by the fact that a mobile phone user is not yet provided with a convent method to automatically receive the notification of the location. The estimated time of arrival (ETA) as that may be posted on houses or bus dispatch time may not be convenient for a mobile phone user.

For these reasons, the above Patent Applications and Patents do not provide effective solution to resolve the difficulties currently encountered by the conventional system configurations and methods for implementing a location tracking device. Therefore a need still exists to implement a signal transmission/reception and processing configuration to make a more effective and convenient location tracking device to overcome the limitations and difficulties confronted by current location tracking systems and techniques.

### SUMMARY OF THE PRESENT INVENTION

It is therefore a first aspect of the present invention to provide a location tracking device implemented with integrated and simplified configuration and signal process methods with a map database to enable an automatic response to calls to provide automatic location tracking. The map data may include a map database with a data base manager to provide location reference for generating short message that include physical address, major cross street, famous building, landmarks, train station or bus station, etc., such that the caller can conveniently track the location through the short message sent back by the tracking device. From a user's aspect, a simple telephone call is all that is required and there is no need for programming or on-site installation procedures after purchase for using the wireless location tracking device of the present invention.

It is another aspect of the present invention to provide a location tracking device implemented with integrated and simplified configuration and signal process methods to enable an automatic location tracking operation by using a miniaturized tracking device. The automatic location tracking operation can be manufactured with standardized packaging and assembly processes such that the wireless location tracking device may be produced with substantially automated manufacturing processes for high volume mass production such that the cost of the wireless portable location tracking device may be provided at a reduced production cost.

Another aspect of the present invention is to provide a location tracking device implemented with integrated and simplified configuration and signal process methods to enable an automatic response to all the incoming calls or as an option to respond selectively only to calls from recognized or authorized phone numbers. The wireless location tracking device is provided with a processor and map data to automatically respond to the calls for sending short messages from a transceiver to indicate the most up-to-date device location. From a user's aspect, a simple telephone call is all that is required to complete the location tracking operation when a short message is sent directly from the wireless location tracking device back to the caller to indicate the location of the device.

Another aspect of the present invention is to provide a location tracking device implemented with integrated and simplified configurations and signal process methods to enable an automatic location tracking operation. The automatic location tracking operation can be implemented with a miniaturized device without a requirement of human operations thus enabling the automatic location tracking to conveniently track the location of a person, a pet, or a vehicle even without notice or alarm of a person in the entire processes in tracking the most up-to-date location.

Another aspect of the present invention is to provide a location tracking device implemented with integrated and simplified configuration and signal process methods and powered by a battery to enable an automatic response to incoming calls to automatically and directly provide messages for indication of location. The wireless location tracking device can therefore be secretly placed on a person, a vehicle, a pet, or an object to track the location without relying on external power supply and without human intervention in the entire operation of carrying out the processes of location tracking.

Another aspect of the present invention is to provide a location tracking device implemented with integrated and simplified configuration and signal process methods to automatically initiate a call back process soon an incoming call is received. The processor controls the transceiver to perform the call back process without requiring a human intervention. The call back process includes the processes of dialing the phone number of the incoming call and sending out the short-message by applying an embedded short-message service (SMS) function. The SMS is a communication protocol that allows the exchanges of text messages between mobile telephonic devices. The short messages sent out by the wireless location device automatically provide the location of the wireless location device.

Briefly, in a preferred embodiment, the present invention discloses a wireless location tracking device includes a geographic location determination processor comprising a map database for determining a geographic location. The location tracking device further includes a transceiver for receiving a wireless communication signal from a communication device to automatically process a message including the geographic location and transmit the message back to the communication device. In an exemplary embodiment, the communication device is a telephonic device, such as a cellular phone implemented with GSM, GPSR, and/or mobile phones implementing the 3G technologies. The message further comprises a short message (SM) for indicating the geographic location on the telephonic device. In another exemplary embodiment, the geographic location determination processor is implemented with a global position system (GPS) for receiving signals from satellites for determining the location of the wireless location tracking device. In another exemplary embodiment, the location tracking device further includes a microprocessor for checking a phone number of the telephonic device for determining whether the phone number is recognized or authorized to receive the message for indicating the geographic location of the wireless location tracking device.

In summary a method to determine a location of wireless location tracking device is disclosed in this invention. The method includes a step of integrating a wireless communication transceiver with a geographic location determination processor including a map database for automatically response to a call to process location data including the latitude and longitude coordinate data in reference to the map database. The method further includes a step of receiving a wireless location enquiry message from the communication device and automatically responding to the wireless location enquiry message by processing a device location message and transmitting the location message back to the communication device to indicate the geographic location of the wireless location tracking device. In an exemplary embodiment, the method further includes a step of checking a phone number of the communication device sending the wireless location inquiry message before processing and responding to the wireless location inquiry message.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 is a functional block diagram of a wireless location tracking device of this invention.

FIG. 2 is configuration of a wireless communication system for implementing the wireless location tracking device of this invention.

FIG. 3 is flowchart for illustrating the processing steps performed by the wireless location tracking device to receive and responding to a device location enquiry message from a communication device such as a telephone for sending a short message)SM) to indication the device location.

### DETAILED DESCRIPTION OF THE PREFERRED EMBODIMENT

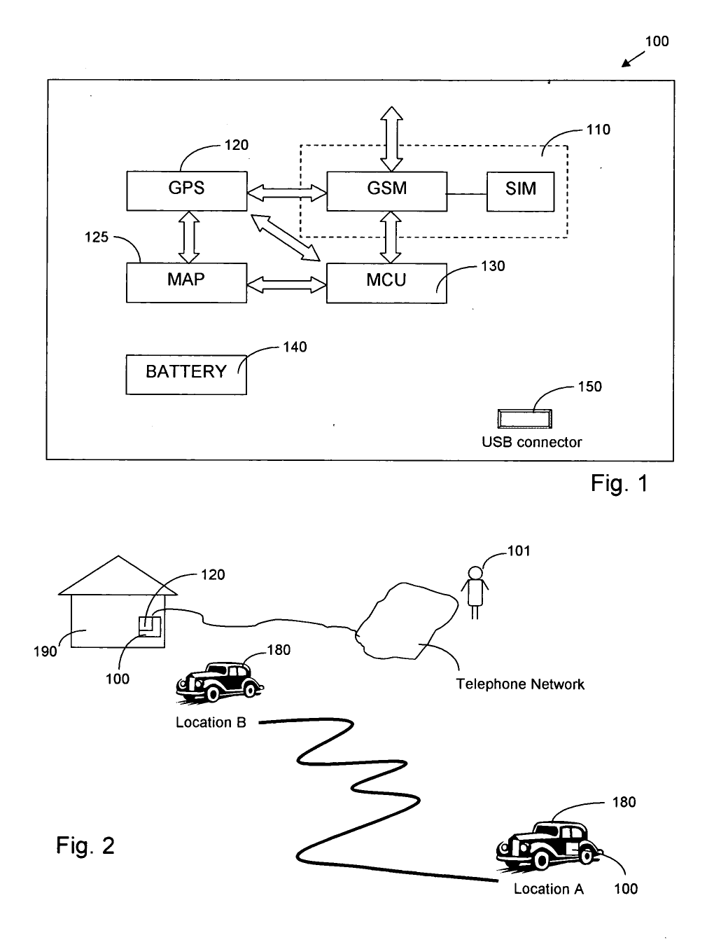

FIG. 1 is a functional block diagram for showing a wireless location tracking device 100 of this invention. The wireless location tracking device includes a transceiver 105 to receive and transmit wireless signals. The wireless tracking device 100 further includes a global position system (GPS) 120 for receiving signals from satellites (not shown) and applies data stored in a map storage 125 to determine the location of the wireless location tracking device 100. Unlike some of the conventional devices that output coordinates of the device location, the device of this invention includes a map database with a location search function implemented in the processor MCU 130 (as further described below) to provide short messages or map to indicate physical address, major cross street, famous building, landmarks, train station or bus station, etc., such that the location can be conveniently located and tracked. The wireless tracking device 100 may further be activated to receive and update map data. The map data update may be automatically activated on a periodical basis or an authorized caller may call and activate a map data update when necessary. The wireless tracking device 100 further includes a microprocessor (MCU) 130 to process signals receives from the GPS 120 and executing preprogrammed instructions to control the operations of the GPS and transceiver 110 to receive and respond to incoming calls to the transceiver to transmit short messages to indicate the location of the wireless tracking device 100. The wireless tracking device 100 further includes a battery 140 and at least an external interface port, such as a universal serial bus (USB) port 150. The battery 140 provides electrical power to operate the device and the external interface port such as an USB port 150 allow for interacting with the MCU 130 to carry out a variety of functions such as update the map data or outputting records of incoming calls or other functions including but not limiting to charging of the battery, etc. As shown in FIG. 1, transceiver 110 may be implemented with a GSM 110-1 and SIM card 110-2 to receive telephonic calls and transmit short messages for indicating the location of the location of the location tracking device 100.

FIG. 2 is a system functional diagram for showing the interaction between a location enquirer 101 who makes a call to the wireless location tracking device that is placed on a person or a vehicle 180. The diagram shows wireless location tracking device travels to different locations from a location A to a location B. Since the location B is inside a building 190, the GPS 120 of the location tracking device 100 would not be able receive the signals sent from the satellites. In the meantime, the most up-to-date, i.e. the latest GPS signals received by the wireless location tracking device is applied to calculate the location and the map data stored in the map storage 125 is applied to locate the address of the building. Therefore, when the location enquirer 101 makes a call to the location tracking device, the transceiver, e.g., the GSM, receives the call. The microprocessor MCU 130 processes the call and transmits the street address of the building as a short message (SM) to the caller 101 to indicate the location B as the latest location of the wireless location tracking device. The location tracking device 100 automatically initiates a call back process soon an incoming call is received. The processor MCU 130 controls the transceiver 110 to perform the call back process without requiring a human intervention.

The call back process includes a step of dialing the phone number of the incoming call from the location enquirer 101 and sending out the short-message by applying an embedded short-message service (SMS) function. The SMS is a communication protocol that allows the exchanges of text messages between mobile telephonic devices. The short messages sent out by the wireless location device automatically provide the location of the wireless location device 100.

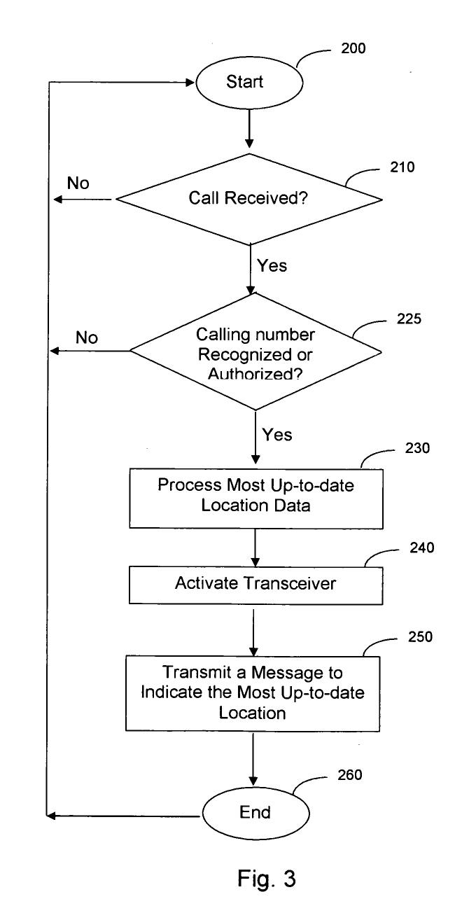

Referring to FIG. 3 for a flowchart for illustrating the processes performed by the wireless location tracking device 100. The processes start (step 200) by checking and determining if an incoming call is received (step 210). If a call is not yet received, the processes start again (step 200) to wait and check again (step 210). When an incoming call is received, the wireless location tracking device 100 may determine whether the calling number is recognized or authorized (step 225). The check of the calling number may be implemented as an optional step. If the caller is a recognized and authorized caller, then the wireless location tracking device 100 applies the GPS signals and the map data to determine the most up-to-date location of the wireless location tracking device (step 230). The wireless location tracking device 100 further activates the transceiver (step 240) to transmit a message to the caller (step 250) to terminate and end the location enquiry call process (step 260). The processes then loop back again to start the processes (step 200) by continuously waiting for an incoming call (step 210).

According to above descriptions, this invention discloses a wireless location tracking device (WLTD) includes a global position system (GPS) for receiving signals and generating data for determining a geographic location of the wireless location tracking device (WLTD). The WLTD further includes a transceiver for receiving an incoming call from a caller requesting a location of the wireless location tracking device. A processor includes a map database for receiving and applying data from the GPS to determine a geographic location of the WLTD in reference to the map database. The processor further controls the transceiver to automatically call back the caller for transmitting a short message to indicate the geographic location of the WLTD. In an exemplary embodiment, the wireless location tracking device further includes a battery for supplying power to the GPS, the transceiver and the processor. In another exemplary embodiment, the transceiver further includes a GSM chip operated with a SIM card. In another exemplary embodiment, the GPS further generating coordinates applicable by the processor in reference to the map database to generate the geographic location of the WLTD.

In summary, the present invention discloses a wireless location tracking device (WLTD) that includes a processor and a transceiver for receiving geographic signals and receiving/transmitting communication signals. The WLTD further includes a map database providing map data to said processor to determine a location of said WLTD on a map according to said map database.

According to above descriptions, this invention further discloses a method to determine a location of wireless location tracking device. The method includes a step of integrating a wireless communication transceiver with a geographic location determination processor including a map database for automatically responding to a call to process location data including the latitude and longitude coordinate data in reference to the map database. In an exemplary embodiment, the method further includes a step of receiving a wireless location enquiry message from the communication device and automatically responding to the wireless location enquiry message by processing a device location message and transmitting the location message back to the communication device to indicate the geographic location of the wireless location tracking device. In another exemplary embodiment, the method further includes a step of checking a phone number of the communication device sending the wireless location inquiry message before processing and responding to the wireless location inquiry message. In another exemplary embodiment, the method further includes a step of checking a phone number of the communication device sending the wireless location inquiry message to determine if the phone number of the communication device is an authorized phone number for transmitting the location message back to the communication device with the authorized phone number to indicate the geographic location of the wireless location tracking device. In another exemplary embodiment, the step of automatically responding to the call to process location data including the latitude and longitude coordinate data in reference to the map database further comprising a step of applying a database manager for processing the coordinate data in reference to the map database for generating short message including physical address, major cross street, famous buildings, landmarks, train station or bus station near the location of the wireless location tracking device. In another exemplary embodiment, the step of automatically responding to the call to process location data including the latitude and longitude coordinate data in reference to the map database further comprising a step of automatically activating the processor to process the location data and generating a short message to indicate a location of the wireless location tracking device and automatically activate a transceiver to call back to a caller of the call for sending the short message without making an audio or visual indication of any of above described processes. In another exemplary embodiment, the step of automatically responding to the call to process location data including the latitude and longitude coordinate data in reference to the map database further comprising a step of automatically activating the processor to process the location data and generating a short message to indicate a location of the wireless location tracking device and automatically activate a transceiver to call back to a caller of the call for sending the short message without human actions for any of above described processes. In another exemplary embodiment, the method further includes a step of connecting a battery for supplying power to the wireless communication transceiver and the geographic location determination processor.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A wireless location tracking device (WLTD) comprising:
a global position system (GPS) for receiving signals and generating data for determining a geographic location of said wireless location tracking device (WLTD);
a transceiver for receiving an incoming call from a caller requesting a location of said wireless location tracking device;
a processor including a map database for receiving and applying data from said GPS to determining a geographic location of said WLTD in reference to said map database; and
said processor further controls said transceiver to automatically call back said caller for transmitting a short message to indicate the geographic location of said WLTD.

2. The wireless location tracking device (WLTD) of claim 1 further comprising:
a battery for supplying power to said GPS, said transceiver and said processor.

3. The wireless location tracking device (WLTD) of claim 1 wherein:
said transceiver further comprising a GSM chip operated with a SIM card.

4. The wireless location tracking device (WLTD) of claim 1 wherein:
said GPS further generating coordinates applicable by said processor in reference to said map database to generate said geographic location of said WLTD.

5. A wireless location tracking device (WLTD) comprising a processor and a transceiver for receiving geographic signals and receiving/transmitting communication signals; said WLTD further comprising:
a map database providing map data to said processor to determine a location of said WLTD on a map according to said map database.

6. The wireless location tracking device (WLTD) of claim 5 further comprising:
a battery for supplying power to said processor and said transceiver.

7. The wireless location tracking device (WLTD) of claim 5 wherein:
said transceiver further comprising a GSM chip operated with a SIM card.

8. The wireless location tracking device (WLTD) of claim 5 wherein:
said processor further includes a global position system (GPS) chip for generating coordinates applicable by said processor in reference to said map database to generate said location of said WLTD on said map.

9. A method to determine a location of wireless location tracking device comprising:
integrating a wireless communication transceiver with a geographic location determination processor including a map database for automatically responding to a call to process location data including the latitude and longitude coordinate data in reference to the map database.

10. The method of claim 9 further comprising:
receiving a wireless location enquiry message from the communication device and automatically responding to the wireless location enquiry message by processing a device location message and transmitting the location message back to the communication device to indicate the geographic location of the wireless location tracking device.

10. The method of claim 9 further comprising:
checking a phone number of the communication device sending the wireless location inquiry message before processing and responding to the wireless location inquiry message.

11. The method of claim 9 further comprising:
checking a phone number of the communication device sending the wireless location inquiry message to determine if said phone number of said communication device is an authorized phone number for transmitting the location message back to the communication device with the authorized phone number to indicate the geographic location of the wireless location tracking device.

12. The method of claim 9 further wherein:
said step of automatically responding to said call to process location data including the latitude and longitude coordinate data in reference to the map database further comprising a step of applying a database manager for processing said coordinate data in reference to said map database for generating short message including physical address, major cross street, famous buildings, landmarks, train station or bus station near said location of said wireless location tracking device.

14. The method of claim 9 further wherein:
said step of automatically responding to said call to process location data including the latitude and longitude coordinate data in reference to the map database further comprising a step of automatically activating said processor to process said location data and generating a short message to indicate a location of said wireless location tracking device and automatically activate a transceiver to call back to a caller of said call for sending said short message without making an audio or visual indication of any of above described processes.

15. The method of claim 8 further wherein:
said step of automatically responding to said call to process location data including the latitude and longitude coordinate data in reference to the map database further comprising a step of automatically activating said processor to process said location data and generating a short message to indicate a location of said wireless location tracking device and automatically activate a transceiver to call back to a caller of said call for sending said short message without human actions for any of above described processes.

16. The method of claim 9 further comprising:
connecting a battery for supplying power to said wireless communication transceiver and said geographic location determination processor.
